(19) United States
(12) Patent Application Publication
(10) Pub. No.: US 2024/0067761 A1
(43) Pub. Date: Feb. 29, 2024

(54) INVERT EMULSION HAVING DOUBLE PARTICLE SIZE DISTRIBUTION, PREPARATION METHOD THEREFOR AND USE THEREOF

(71) Applicant: JIANGSU FEYMER TECHNOLOGY CO., LTD., Suzhou (CN)

(72) Inventors: Guofeng HE, Suzhou (CN); Zhuqing LIU, Suzhou (CN); Qiang LIU, Suzhou (CN); Qin WANG, Suzhou (CN); Tao ZHOU, Suzhou (CN); Suling YIN, Suzhou (CN)

(21) Appl. No.: 18/261,166

(22) PCT Filed: Apr. 12, 2021
(86) PCT No.: PCT/CN2021/086609

§ 371 Date: Jul. 12, 2023

(30) Foreign Application Priority Data
Dec. 16, 2020 (CN) 202011483503.0

(51) Int. Cl. C08F 2/00; C08F 2/32

(52) U.S. Cl. CPC C08F 2/001; C08F 2/32; C02F 1/56

(57) ABSTRACT

An invert emulsion having double particle size distribution, the invert emulsion having a particle size distribution of latex particles between 20 nm and 70 nm and between 100 nm and 500 nm in the same invert emulsion system. A preparation method for an invert emulsion comprises: forming an emulsion A and an emulsion B having different particle sizes by controlling an emulsifier system and an emulsification means, and preparing in one step an invert emulsion the particle size of which has bimodal distribution by means of a three-stage polymerization reaction between the emulsion A and the emulsion B in the same system. The invert emulsion is used as a water treatment flocculant, a sludge dewatering agent and a papermaking auxiliary agent, and in particular, the sludge dewatering agent fabricated from the invert emulsion is used for dewatering sludge.

### BACKGROUND OF THE INVENTION

### 1. Field of the Invention

The invention relates to the technical field of polymerizing an invert emulsion, and more particularly, to an invert emulsion having double particle size distribution, a preparation method therefor and a use thereof.

### 2. Description of the Related Art

Pollutants and nutrients in sewage continue to accumulate in the presence of a large number of bacteria, to form an gradually increased aggregate structure. The aggregate structure finally settles in water to form sludge. The reason why the sludge contains high moisture content is that the sludge is tightly bonded to water molecules and has different phases: free-form water, physically bound water (including capillary/interstitial water, colloidal/surface adsorbed water), chemically bound water (including intracellular water and molecular water). The free-form water and the physically bound water can be dehydrated by adding common flocculants for flocculation and sedimentation, while the chemically bound water can be removed by breaking chemical bonds due to its strong binding force. Now the most widely used sludge dewatering agent is a combination of inorganic conditioners and organic flocculants. The Inorganic conditioners comprise lime, fly ash, iron salts, and aluminum salts, and the main function of the inorganic conditioners is to destroy the binding force between sludge and the water molecules, so they are also called “sludge modifiers”. Then a polymeric flocculant, such as polyacrylamide, is added for flocculation and sedimentation, followed by a dewatering process carried out by a dewatering equipment. Although the sludge can be dewatered to less than 60% after subjecting to conditioning and pressing processes by using this method, a total dosage ratio of the conditioners is substantially more than 20% of the absolutely dry sludge, or up to 40%. In addition, chemicals, such as the limb, the fly ash, are basically added in the form of dry solids. Although the volume of the sludge is reduced after being subjected to the sludge dewatering, a total amount of the final sludge to be disposed is increased, which leads to a secondary increase in costs for subsequent disposal of the sludge. Therefore, such practice does not meet the overall requirements and the development trend featuring “minimization, stabilization, harmlessness and resource utilization”.

The Chinese Patent No. CN109592879A discloses a novel organic compound sludge conditioning modifier. Quicklime, iron salts, aluminum salts, for example, are not contained in the modifier, but various organic conditioners are contained therein. The various organic conditioners comprise short-chain polyacrylamide, high-ionic polyacrylamide, a quaternary ammonium salt, and chitosan; polyacrylamide emulsion; alkyl glycoside, glycine betaine. Wherein the high-ionic polyacrylamide and the quaternary ammonium salt are mentioned, and they are intended to destroy functions of cell walls. However, the conditioners disclosed in the patent is a mixture of the various organic conditioners, and a usage of the compound conditioner is provided in the patent. The physical compounding process has the following disadvantages: the mixing is uneven, different components have different forms and solubility, and there is a possibility of uneven solubility, so it is too late for some components to have an effect, and the overall synergistic effect cannot be maximized.

In conclusion, there is thus an urgent need for a novel compound for high-efficient sludge dewatering. The compound helps to dewater the sludge efficiently, and it can be prepared efficiently, so as to solve problems in term of sludge treatment in the prior art.

### SUMMARY OF THE INVENTION

Purpose of the invention: given that the foregoing problems exist in the prior art, the present invention provides an invert emulsion having double particle size distribution, a preparation method therefor and a use thereof.

The technical solution for implementing the present invention is as follows:
the invention discloses an invert emulsion having double particle size distribution, the invert emulsion having a particle size distribution of latex particles between 20 nm and 70 nm and between 100 nm and 500 nm in the same invert emulsion system.

A preparation method for the above-mentioned invert emulsion comprises: forming an emulsion A and an emulsion B having different particle sizes by controlling an emulsifier system and an emulsification means, and preparing in one step an invert emulsion the particle size of which has bimodal distribution by means of a three-stage polymerization reaction between the emulsion A and the emulsion B in the same system.

Preferably, a preparation method for the emulsion A and the emulsion B comprises: preparing the emulsion A: adding a compound emulsifier A and oil to a reactor A, and stirring the compound emulsifier A and the oil well to form an oil phase A; adding a functional monomer A aqueous solution while stirring the mixture at a rotation speed of 600-1000 rpm, then performing shearing and dispersion on a homogeneous emulsifying machine for a period of 5 to 20 minutes to obtain the emulsion A;
preparing the emulsion B: adding a compound emulsifier B and oil to a batching kettle B, and stirring the compound emulsifier B and the oil well to form an oil phase B; adding a functional monomer B aqueous solution while stirring the mixture at a rotation speed of 100-300 rpm, then keeping stirring for a period of 10 to 30 minutes at the same rotation speed of 100-300 rpm to obtain the emulsion B.

Preferably, the method for preparing in one step an invert emulsion the particle size of which has bimodal distribution by means of a three-stage polymerization reaction between the emulsion A and the emulsion B in the same system comprises:
performing a first-stage polymerization reaction: an initiator A is added to the emulsion A under the protection of nitrogen gas, and the polymerization reaction is performed at 10-30° C. for a period of 30-90 minutes, the reaction is not suspended until the conversion rate reaches 40-60% to form a semi-emulsion A;
performing a second-stage polymerization reaction: the emulsion B is added dropwise to the semi-emulsion A while the semi-emulsion A is stirred at a rotation speed of 300-600 rpm, addition of the emulsion B is suspended when an amount of 40-80% of the emulsion B is added, an initiator B is added to a system under the protection of nitrogen gas, and the polymerization reaction is performed at 30-60° C. for another period of 30-90 minutes; and performing a third-stage polymerization reaction: still under the protection of nitrogen gas, a remaining 20-60% of the emulsion B is added dropwise while the polymerization reaction continues, after the whole emulsion B is added, the reaction is carried out at 50-90° C. for a period of 2-5 hours until the reaction is completed, so as to obtain the invert emulsion having double particle size distribution is obtained.

Preferably, a ratio of the emulsion A to the emulsion B is in a range of 1/1 to 4/1. The ratio of the emulsion A to the emulsion B is selected so that, on the one hand, it is beneficial to control the degree of the polymerization reaction, that is, the first-stage polymerization reaction, it controls the emulsion A reacts by 40%-60% and the remaining emulsion A continues to react with the emulsion B in the second-stage polymerization reaction; on the other hand, the emulsion A is subjected to the polymerization reaction first, and when its proportion is relatively high, it is conducive to the stability of the three-stage polymerization process, and in the case of a preferred ratio, the final invert emulsion having double particle size distribution has a relatively high stability.

Preferably, the compound emulsifier A has a HLB of 5-9, an amount of the compound emulsifier A accounts for 2 to 4% by mass of the total amount of the system; the compound emulsifier B has a HLB of 2-5, an amount of the compound emulsifier B accounts for 1 to 3% by mass of the total amount of the system. In the present invention, by limiting the HLB of the compound emulsifier A and the compound emulsifier B, different HLBs will affect a surface state of the latex particles and affect the stability of the emulsion. The Preferred HLBs given in the present invention are beneficial to prepare a stable invert emulsion having double particle size distribution; in the present invention, by limiting different dosages of the compound emulsifier A and the compound emulsifier B, the double particle size distribution can be better achieved. The emulsion A, containing a larger amount of the compound emulsifier, has a smaller particle size, and the emulsion B, containing a smaller amount of the compound emulsifier, has a larger particle size.

Preferably, the compound emulsifier A and the compound emulsifier B are composed of one or two or more selected from the group consisting of sorbitan monooleate (S-80), sorbitan monostearate (S-60), sorbitan trioleate (S-85), sorbitan tristearate (S-65), sorbitan laurate (S-20), polyoxyethylene (5EO) sorbitan monooleate (T-81), polyoxyethylene (20E0) sorbitan monooleate (T-80), polyoxyethylene (4EO) sorbitan monostearate (T-61), polyoxyethylene (20EO) sorbitan monostearate (T-60), polyoxyethylene (20EO) sorbitan trioleate (T-85), polyoxyethylene (20EO) sorbitan tristearate (T-65), and polyoxyethylene (4EO) sorbitan laurate (T-21). By limiting the type of the compound emulsifier A and the compound emulsifier B selected for this purpose, it is beneficial to obtain the compound emulsifier A and the compound emulsifier B, thus, it is beneficial to prepare a stable invert emulsion having double particle size distribution.

Preferably, the oil used in the preparation of the emulsion A and the emulsion B is aliphatic hydrocarbon or aromatic hydrocarbon; preferably, industrial white oil, light environmental protection oil, kerosene; more preferably, it is one selected from or a mixture of one or two or more of the following oils: industrial white oil 3 #, industrial white oil 5 #, industrial white oil 10 #, solvent oil D60, solvent oil D80, solvent oil D100, and solvent oil D110, and the oil accounts for 15-25% of the total amount of the system. The oil selected in the present invention is all long-chain alkane, which are non-toxic and harmless, so the prepared products will not cause secondary pollution when used in sludge treatment, water treatment, papermaking and other fields, and meet the requirements of environmental protection; the amount of oil used is beneficial to prepare the stable invert emulsion having double particle size distribution.

Preferably, the functional monomer A aqueous solution is a mixture formed from a complete dissolution of a functional monomer A, water and an auxiliary agent; the functional monomer A is one or two or more selected from the group consisting of acrylamide, methacrylamide, methacryloyloxyethyltrimethylammonium chloride, acryloyloxyethyltrimethylammonium chloride, dimethyldiallylammonium chloride, methylacryloyloxyethyldimethylbenzylammonium chloride and methacryloylpropyltrimethylammonium chloride. In the present invention, the functional monomer A is a common acrylamide and quaternary ammonium salt monomer. The free radical activity of the monomer is relatively high, which is better for the preparation of a polymer with a high molecular weight in the emulsion A with a small particle size.

Preferably, the functional monomer B aqueous solution is a mixture formed from a complete dissolution of a functional monomer B, water and an auxiliary agent; the functional monomer B is an unsaturated quaternary ammonium salt; the functional monomer B is preferably one, two or more quaternary ammonium salts selected from the group consisting of acrylic quaternary ammonium salt, acrylamide quaternary ammonium salt, allyl (oxygen) group quaternary ammonium salt and styrene quaternary ammonium salt; more preferably, it is one, two or more quaternary ammonium salts selected from the group consisting of methacryloyloxyethyl trimethylammonium chloride, acryloyloxyethyl trimethylammonium chloride, dimethyl diallyl ammonium chloride, methacryloyloxyethyl dimethyl benzyl ammonium chloride, and methacryloyloxyethyl trimethylammonium chloride. In the present invention, the functional monomer B has a molecular structure containing a group with a relatively high steric hindrance effect. Such a group plays a role in stabilizing the free radical formed. As a result, the free radical activity is reduced, a polymer formed from the reaction has a relatively lower molecular weight, so it is suitable for presence in the emulsion B having a larger particle size.

Preferably, the auxiliary agent in the functional monomer A aqueous solution and the functional monomer B aqueous solution is one, two or more selected from the group consisting of polyethylene glycol diacrylate, sodium formate, sodium acetate, sodium hypophosphite, disodium ethylenediaminetetraacetate, sodium diethylenetriamine pentaacetate, urea, N, N′-methylene bisacrylamide, hydroxysuccinic acid and adipic acid, in an amount of 0-2% of the total amount of the system.

Preferably, a ratio of the functional monomer A to the functional monomer B is in a range of 1/2 to 4/1. In the present invention, a selected ratio of the functional monomer A to the functional monomer B is conductive to the preparation of products having double particle size distribution and accordingly having different molecular weights in the presence of the double particle size distribution. A part, small in particle size and high in molecular weight, has a suitable flocculation effect, and a part, large in particle size and low in molecular weight, has a suitable wall breaking effect. Therefore, the invert emulsion having double particle size distribution has advantages in water treatment, sludge dewatering and papermaking and other aspects.

For the selection of the functional monomer A and the functional monomer B, a part with a small particle size has a slightly low discharge density, but the polymer molecular weight can be high; a part with a large particle size has a high discharge density, but the polymer molecular weight can be low; the particle size can be adjusted by controlling an amount of the compound emulsifier, a stirring rate and an emulsification means; after an emulsion having different particle size distribution is formed, multi-stage polymerization is carried out; according to an emulsion polymerization mechanism, after primary free radicals and short-chain free radicals are produced, they grow in micelles or colloidal particles, and it will not stop until another free radical enters. Under the same conditions, the more micelles or colloidal particles in a small particle size system, the lower the probability of the free radicals entering the same micelle, so the free radicals have a longer life. Therefore, it is easy to prepare polymers with high molecular weight in the small particle size system, instead, the molecular weight of a polymer prepared in a large particle size system is relatively low. In the meantime, through distribution of the functional monomers, the free radical activity of monomers with low charge density is also high, which is distributed in small particle size emulsion, which can further help the small particle size emulsion to prepare high molecular weight polymers; however, monomers with high charge density have high free radical stability and low activity due to steric hindrance effects, so the molecular weight of a polymer obtained from the reaction is low.

Preferably, the initiator A is a redox initiator, wherein the oxidant is selected from one, two or more of sodium persulfate, potassium persulfate, ammonium persulfate, potassium bromate, sodium bromate and tert-butyl hydroperoxide; the reducing agent is selected from one, two or more of sodium sulfite, sodium bisulfate, sodium metabibisulfite, sodium thiosulfate and sodium formaldehyde hyposulfate; an amount of the initiator A accounts for 0.0005%-0.01% by mass of the total amount of the system. The initiator A in the present invention is the redox initiator, which can react at low temperature and is suitable for use in a front stage of polymerization. Its type and dosage are selected so that it may help to control a reaction rate and further help to prepare high molecular weight polymers.

Preferably, the initiator B is selected from one, two or more of azodiisobutylamine hydrochloride, azodiisopropyl imidazoline hydrochloride, azodiisobutylamine hydrochloride, azodiisobutyronitrile, 2,2′-Azobisisoheptonitrile, sodium persulfate, potassium persulfate and ammonium persulfate; an amount of the initiator B accounts for 0.005%-0.02% by mass of the total amount of the system. The initiator B in the present invention is a thermal initiator with high decomposition temperature, so it is suitable for use in a post stage of polymerization. Its type and dosage are selected so that it may help to control a reaction rate and further help to prepare middle or low molecular weight polymers.

Preferably, a rate of adding the emulsion B dropwise in the second-stage polymerization reaction is in a range of 5-10 mL/min, and a rate of adding the emulsion B dropwise in the third-stage polymerization reaction is in a range of 0.5-5 mL/min. The emulsion B in the present invention is added dropwise at different rates to control the particle size distribution and polymerization reaction process, so as to ensure the preparation of the emulsion having double particle size distribution and to control the reaction rate and conversion rate; in the present invention, the rate of adding the emulsion B dropwise in the second-stage polymerization reaction is faster, so that the large particle size emulsion can quickly enter the overall system and react quickly to avoid the interruption of the reaction when the two-stage reaction is switched; in the third-stage polymerization, a large amount of initiator is already present in the system. The rate of adding the emulsion B dropwise can be lowered to control the reaction rate. In this way, instability of the system, resulting from a faster reaction rate, can be avoided. In addition, the reaction rate can be controlled to further improve the conversion rate.

A use of the above-mentioned invert emulsion is illustrated. The invert emulsion is used as a water treatment flocculant, a sludge dewatering agent and a papermaking auxiliary agent, and in particular, the sludge dewatering agent fabricated from the invert emulsion is used for dewatering sludge. Only the invert emulsion provided in the present invention is used, without the use of other inorganic conditioners or various organic conditioners, to achieve a filter cake water content of below 50% after sludge dewatering.

In the multi-stage polymerization process of the present invention, a redox system is used in the first-stage polymerization to prepare an emulsion, which is emulsion A, with a conversion of 40%-60% and a particle size of 20 nm-70 nm; in the second-stage polymerization, a part of emulsion, which is the emulsion B, with large particle size of 100 nm-500 nm, is added dropwise, and a high-temperature initiator, which is the initiator B, is added to continue the polymerization reaction, and the remaining small particle size emulsion reacts with 40%-80% of the large particle size emulsion added dropwise; the third-stage polymerization reaction continues to control the progress of the reaction by controlling the rate of adding the large particle size emulsion. In the meantime, the small particle size emulsion basically reacts in the first- and second-stage polymerization reactions. At the third-stage polymerization, the small particle size emulsion below 2% remains to react, and the remaining small unreacted small particle size emulsion and the remaining 20%-60% large particle size emulsion continue to react, and finally, an invert emulsion having double particle size distribution is prepared. In the preparation method of the invention, particles of the emulsion whose particle size is between 20 nm and 70 nm and between 100 nm and 500 nm can be distributed uniformly among each other. If the large particle size emulsion is added after the small particle size emulsion is completely reacted, the movement of the large particle size emulsion is blocked due to high viscosity occurs after the reaction is completed, and particles of two particle sizes are not evenly distributed. If the large particle size emulsion is added before the small particle size emulsion is reacted, both emulsion are solution dispersions, according to the principle of similarity and compatibility, the two emulsion is easy to be integrated, and the aggregation of particles is more obvious, resulting in an overall uneven particle size, so it fails to reach the particle distribution state of an invert emulsion having double particle size distribution prepared by the preparation method of the present invention, and thus it fails to achieve a dewatering effect in terms of sludge dewatering with the invert emulsion in subsequent stages.

In the present invention, preparing in one step an invert emulsion the particle size of which has bimodal distribution by means of a multi-stage invert emulsion polymerization reaction by controlling an emulsifier system and an emulsification means, the particle size of the emulsion disclosed in the present invention is between 20 nm and 70 nm and between 100 nm and 500 nm; types and amounts of the initiators A and B are controlled by adjusting types and ratios of the functional monomers A and B, then the emulsion is distributed: first of all, a first part of the emulsion is intensified to be emulsified to obtain a small particle size emulsion, and an oil phase of a second emulsion is added during the reaction, then a second part of water phase is added to emulsify at low and medium strength to prepare a part of emulsion with large particle size. The polymerization is carried out in stages. After the reaction of the first part is carried out halfway, the second part is added to emulsify and polymerize; with the multi-stage invert emulsion polymerization method, a macromolecule of the large particle size part has high cationic charge density and low molecular weight, and a macromolecule of the small particle size part has low cationic charge density and high molecular weight. The high cationic charge density of the former has a destructive effect on the cell wall, and the high molecular weight of the latter has a strong flocculating effect. Therefore, when the invert emulsion prepared by the present invention is used as a sludge dewatering agent, the invert emulsion product has dual effects on breaking the cell wall and flocculating the sludge, then high efficient dewatering can be achieved. In this way, water content of a filter cake subjected to dewatering process is below 50%. The present invention has the advantages of having high solid content of above 50%, achieving high efficient dewatering with a small amount of sludge dewatering agent, having fast dissolution, being convenient to use and so on. The sludge dewatering agent prepared by the invert emulsion in the present invention can dissolve completely within three minutes, so it can meet the requirements of instant or online dissolution.

By adopting the above-mentioned technical solutions, the present invention has the following beneficial effects:

(1) the preparation method disclosed in the present invention comprises forming an emulsion A and an emulsion B having different particle sizes by controlling an emulsifier system and an emulsification means, and preparing in one step an invert emulsion the particle size of which has bimodal distribution by means of a three-stage polymerization reaction between the emulsion A and the emulsion B in the same system. The particle size of particles in the invert emulsion is between 100 nm and 500 nm and between 20 nm and 70 nm; the preparation method disclosed in the present invention is safe, efficient, and convenient to use.

(2) with the invert emulsion prepared by the preparation method in the present invention, the particle size of particles in the invert emulsion is between 20 nm and 70 nm and between 100 nm and 500 nm. This two groups of particles having different particle sizes can be interspersed with each other. Particles having large particle size are uniformly distributed among particles having small particle size, and the particles having small particle size are uniformly distributed among the particles having large particle size. A macromolecule of the large particle size part has high cationic charge density and low molecular weight, and a macromolecule of the small particle size part has low cationic charge density and high molecular weight. The high cationic charge density of the former has a destructive effect on the cell wall, and the high molecular weight of the latter has a strong flocculating effect. Both are uniformly distributed when in use, so that they can cooperate with each other to achieve better effects.

(3) The invert emulsion prepared by the preparation method in the present invention can be independently used as a sludge dewatering agent and it can achieve an excellent effect. Specifically, water content of a filter cake is below 50% after sludge dewatering, and the present invention has advantages of having high solid content, which is above 50%, low consumption, low costs, fast dissolution, being convenient to use. It can dissolve completely within 3 minutes, so that it can meet the requirements of instant dissolution.

(4) When the invert emulsion having double particle size distribution prepared by the preparation method in the present invention is used as a sludge dewatering agent, it has remarkable effects, namely, water content of a filter cake is below 50% after sludge dewatering, a problem of an increase in sludge from the use of quicklime, iron salts and aluminum salts can be avoided, and harm to equipment and water quality can also be avoided.

(5) The emulsion B in the present invention is added dropwise at different rates to control the particle size distribution and polymerization reaction process, so as to ensure the preparation of the emulsion having double particle size distribution and to control the reaction rate and conversion rate; in the present invention, the rate of adding the emulsion B dropwise in the second-stage polymerization reaction is faster, so that the large particle size emulsion can quickly enter the overall system and react quickly to avoid the interruption of the reaction when the two-stage reaction is switched; in the third-stage polymerization, a large amount of initiator is already present in the system. The rate of adding the emulsion B dropwise can be lowered to control the reaction rate. In this way, instability of the system, resulting from a faster reaction rate, can be avoided. In addition, the reaction rate can be controlled to further improve the conversion rate.

### BRIEF DESCRIPTION OF THE DRAWINGS

FIG. 1 is a DLS diagram of an invert emulsion sample prepared in Example 1;

FIG. 2 is a DLS diagram of an invert emulsion sample prepared in Comparative Example 1;

FIG. 3 is a TEM image of an invert emulsion sample prepared by a preparation method in Example 1;

FIG. 4 is a TEM image of an invert emulsion sample prepared by a conventional invert emulsion preparation method in Control Example 1; and

FIG. 5 is a TEM image of a compound emulsion sample obtained from physical mixing of emulsions having different particle sizes in Control Example 2.

### DETAILED DESCRIPTION

The technical solutions of the present invention will be described hereinafter with reference to the accompanying drawings and particular embodiments, but the invention is not limited thereto.

### Example 1

An invert emulsion having double particle size distribution, an invert emulsion having double particle size distribution in this example, the invert emulsion having a particle size distribution of latex particles between 20 nm and 70 nm and between 100 nm and 500 nm in the same invert emulsion system.

A preparation method for preparing the above-mentioned invert emulsion, the preparation method comprises forming an emulsion A and an emulsion B having different particle sizes by controlling an emulsifier system and an emulsification means, and preparing in one step an invert emulsion the particle size of which has bimodal distribution by means of a three-stage polymerization reaction between the emulsion A and the emulsion B in the same system, preparation steps are shown as follows:

Step 1, preparing the emulsion A and the emulsion B:
preparing the emulsion A: adding a compound emulsifier A and oil to a reactor A, and stirring the compound emulsifier A and the oil well to form an oil phase A; adding a functional monomer A aqueous solution while stirring the mixture at a rotation speed of 600-1000 rpm, then performing shearing and dispersion on a homogeneous emulsifying machine for a period of 5 to 20 minutes to obtain the emulsion A;
preparing the emulsion B: adding a compound emulsifier B and oil to a batching kettle B, and stirring the compound emulsifier B and the oil well to form an oil phase B; adding a functional monomer B aqueous solution while stirring the mixture at a rotation speed of 100-300 rpm, then keeping stirring for a period of 10 to 30 minutes at the same rotation speed of 100-300 rpm to obtain the emulsion B.

In Step 1 of this example, the compound emulsifier A has a HLB of 5-9, an amount of the compound emulsifier A accounts for 2 to 4% by mass of the total amount of the system; the compound emulsifier B has a HLB of 2-5, an amount of the compound emulsifier B accounts for 1 to 3% by mass of the total amount of the system. The compound emulsifier A and the compound emulsifier B in this example are composed of one or two or more selected from the group consisting of sorbitan monooleate (S-80), sorbitan monostearate (S-60), sorbitan trioleate (S-85), sorbitan tristearate (S-65), sorbitan laurate (S-20), polyoxyethylene (5EO) sorbitan monooleate (T-81), polyoxyethylene (20EO) sorbitan monooleate (T-80), polyoxyethylene (4EO) sorbitan monostearate (T-61), polyoxyethylene (20EO) sorbitan monostearate (T-60), polyoxyethylene (20EO) sorbitan trioleate (T-85), polyoxyethylene (20EO) sorbitan tristearate (T-65), and polyoxyethylene (4EO) sorbitan laurate (T-21). In this example, the oil used in the preparation of the emulsion A and the emulsion B is aliphatic hydrocarbon or aromatic hydrocarbon; preferably, industrial white oil, light environmental protection oil, kerosene; more preferably, it is one or two or more selected from the following oils: industrial white oil 3 #, industrial white oil 5 #, industrial white oil 10 #, solvent oil D60, solvent oil D80, solvent oil D100, and solvent oil D110, or a combination thereof, and the oil accounts for 15-25% of the total amount of the system.

In this example, in Step 1, a ratio of the functional monomer A to the functional monomer B is in a range of 1/2 to 4/1. The functional monomer A aqueous solution is a mixture formed from a complete dissolution of a functional monomer A, water and an auxiliary agent; the functional monomer A is selected from one, two or more of acrylamide, methacrylamide, methacryloyloxyethyltrimethylammonium chloride, acryloyloxyethyltrimethylammonium chloride, dimethyldiallylammonium chloride, methylacryloyloxyethyldimethylbenzylammonium chloride and methacryloylpropyltrimethylammonium chloride; the functional monomer B aqueous solution is a mixture formed from a complete dissolution of a functional monomer B, water and an auxiliary agent; the functional monomer B is an unsaturated quaternary ammonium salt; the functional monomer B is preferably one, two or more quaternary ammonium salts selected from the group consisting of acrylic quaternary ammonium salt, acrylamide quaternary ammonium salt, allyl (oxygen) group quaternary ammonium salt and styrene quaternary ammonium salt; More preferably, it is one, two or more quaternary ammonium salts selected from the group consisting of methacryloyloxyethyl trimethylammonium chloride, acryloyloxyethyl trimethylammonium chloride, dimethyl diallyl ammonium chloride, methacryloyloxyethyl dimethyl benzyl ammonium chloride, and methacryloyloxyethyl trimethylammonium chloride; the auxiliary agent in the functional monomer A aqueous solution and the functional monomer B aqueous solution is selected from one, two or more of polyethylene glycol diacrylate, sodium formate, sodium acetate, sodium hypophosphite, disodium ethylenediaminetetraacetate, sodium diethylenetriamine pentaacetate, urea, N, N′-methylene bisacrylamide, hydroxysuccinic acid and adipic acid, in an amount of 0-2% of the total amount of the system.

Step 2, preparing in one step an invert emulsion the particle size of which has bimodal distribution by means of a three-stage polymerization reaction between the emulsion A and the emulsion B prepared in Step 1 in the same system, a ratio of the emulsion A and the emulsion B is in a range of 1/1 to 4/1, detailed steps are as follows:
performing a first-stage polymerization reaction: an initiator A is added to the initiator A under the protection of nitrogen gas, and the polymerization reaction is performed at 10-30° C. for a period of 30-90 minutes, the reaction is not suspended until the conversion rate reaches 40-60% to form a semi-emulsion A;
performing a second-stage polymerization reaction: the emulsion B is added dropwise at a rate of 5˜10 mL/min to the semi-emulsion A while the semi-emulsion A is stirred at a rotation speed of 300-600 rpm, addition of the emulsion B is suspended when an amount of 40-80% of the emulsion B is added, an initiator B is added to a system under the protection of nitrogen gas, and the polymerization reaction is performed at 30-60° C. for another period of 30-90 minutes; and performing a third-stage polymerization reaction: still under the protection of nitrogen gas, a remaining 20-60% of the emulsion B is added dropwise at a rate of 5˜10 mL/min while the polymerization reaction continues, after the whole emulsion B is added the reaction is carried out at 50-90° C. for a period of 2-5 hours until the reaction is completed, so as to obtain the invert emulsion having double particle size distribution.

In this example, the emulsion B is added dropwise at different rates to control the particle size distribution and polymerization reaction process, so as to ensure the preparation of the emulsion having double particle size distribution and to control the reaction rate and conversion rate; in the present invention, the rate of adding the emulsion B dropwise in the second-stage polymerization reaction is faster, so that the large particle size emulsion can quickly enter the overall system and react quickly to avoid the interruption of the reaction when the two-stage reaction is switched; in the third-stage polymerization, a large amount of initiator is already present in the system. The rate of adding the emulsion B dropwise can be lowered to control the reaction rate. In this way, instability of the system, resulting from a faster reaction rate, can be avoided. In addition, the reaction rate can be controlled to further improve the conversion rate.

In Step 2 of this example, the initiator A is a redox initiator, wherein the oxidant is selected from one, two or more of sodium persulfate, potassium persulfate, ammonium persulfate, potassium bromate, sodium bromate and tert-butyl hydroperoxide; the reducing agent is selected from one, two or more of sodium sulfite, sodium bisulfate, sodium metabibisulfite, sodium thiosulfate and sodium formaldehyde hyposulfate; an amount of the initiator A accounts for 0.0005%-0.01% by mass of the total amount of the system; the initiator B is selected from one, two or more of azodiisobutylamine hydrochloride, azodiisopropyl imidazoline hydrochloride, azodiisobutylamine hydrochloride, azodiisobutyronitrile, 2,2′-Azobisisoheptonitrile, sodium persulfate, potassium persulfate and ammonium persulfate; an amount of the initiator B accounts for 0.005%-0.02% by mass of the total amount of the system.

This example discloses a use of the above-mentioned invert emulsion. The invert emulsion is used as a water treatment flocculant, a sludge dewatering agent and a papermaking auxiliary agent, and in particular, the sludge dewatering agent fabricated from the invert emulsion is used for dewatering sludge. Only the invert emulsion provided in this example is used, without the use of other inorganic conditioners or various organic conditioners, to achieve a filter cake water content of below 50% after sludge dewatering.

In the multi-stage polymerization process of the present invention, a redox system is used in the first-stage polymerization to prepare an emulsion, which is emulsion A, with a conversion rate of 40%-60% and a small particle size of 20 nm-70 nm; in the second-stage polymerization, a part of emulsion, which is the emulsion B, with large particle size of 100 nm-500 nm, is added dropwise, and a high-temperature initiator, which is the initiator B, is added to continue the polymerization reaction, and the remaining small particle size emulsion reacts with 40%-80% of the large particle size emulsion added dropwise; the third-stage polymerization reaction continues to control the progress of the reaction by controlling the rate of adding the large particle size emulsion. In the mean time, the small particle size emulsion basically reacts in the first- and second-stage polymerization reactions. At the third-stage polymerization, the remaining small particle size emulsion below 2% remains to react, and the remaining small unreacted small particle size emulsion and the remaining 20%-60% large particle size emulsion continue to react, and finally, an invert emulsion having double particle size distribution is prepared. In the preparation method of the this example, particles of the emulsion whose particle size is between 20 nm and 70 nm and between 100 nm and 500 nm can be distributed uniformly among each other. If the large particle size emulsion is added after the small particle size emulsion is completely reacted, the movement of the large particle size emulsion is blocked due to high viscosity occurs after the reaction is completed, and particles of two particle sizes are not evenly distributed. If the large particle size emulsion is added before the small particle size emulsion is reacted, both emulsion are solution dispersions, according to the principle of similarity and compatibility, the two emulsion is easy to be integrated, and the aggregation of particles is more obvious, resulting in an overall uneven particle size, so it fails to reach the particle distribution state of an invert emulsion having double particle size distribution prepared by the preparation method of the present invention, and thus it fails to achieve a dewatering effect in terms of sludge dewatering with the invert emulsion in subsequent stages.

In this example, preparing in one step an invert emulsion the particle size of which has bimodal distribution by means of a multi-stage invert emulsion polymerization reaction by controlling an emulsifier system and an emulsification means, the particle size of the emulsion disclosed in this example is between 20 nm and 70 nm and between 100 nm and 500 nm; types and amounts of the initiators A and B are controlled by adjusting types and ratios of the functional monomers A and B. With the multi-stage invert emulsion polymerization method, a macromolecule of the large particle size part has high cationic charge density and low molecular weight, and a macromolecule of the small particle size part has low cationic charge density and high molecular weight. The high cationic charge density of the former has a destructive effect on the cell wall, and the high molecular weight of the latter has a strong flocculating effect. Therefore, when the invert emulsion prepared by this example is used as a sludge dewatering agent, the invert emulsion product has dual effects on breaking the cell wall and flocculating the sludge, then high efficient dewatering can be achieved.

In this example, an invert emulsion is prepared according to the above-mentioned method, the method comprises steps of:

Step 1, preparing the emulsion A and the emulsion B:
preparing the emulsion A: 531 g of methacryloyloxyethyl trimethylammonium chloride and 29 g of deionized water were added to a beaker A and mixed well, the pH of the solution was adjusted to 3.5 to obtain an A aqueous solution; then 7 g of S-80, i.e. sorbitol monooleate, 33 g of T-81, i.e. polyoxyethylene sorbitol monooleate, and 150 g of industrial white oil 5 # were added to a reactor A and mixed well, then the A aqueous solution was added while agitated at a rotation speed of 800 rpm, followed by shear and dispersion on a homogeneous emulsifying machine for 10 minutes to obtain the emulsion A;
preparing the emulsion B: 141 g of dimethyldiallyl ammonium chloride, 9 g of deionized water and 0.15 g of polyethylene glycol diacrylate were added to a beaker B, the resultant solution was stirred completely before its pH was adjusted to 3.5 to obtain an aqueous solution B; then 30 g of S-80, i.e. sorbitol monooleate, and 70 g of industrial white oil 5 #, were mixed in a batching kettle B, and then the aqueous solution B was added at the rotation of 200 rpm; after all of the aqueous solution B was added, continued to stir the solution to obtain the emulsion B;

Step 2, preparing in one step an invert emulsion the particle size of which had bimodal distribution by means of a three-stage polymerization reaction between the emulsion A and the emulsion B prepared in Step 1 in the same system, detailed steps were as follows:
performing a first-stage polymerization reaction: 0.1 g of ammonium persulfate with a mass concentration of 10% was added to the emulsion A under the protection of nitrogen gas, and a solution of sodium metabibisulfite with a mass concentration of 0.3% was slowly added dropwise at 10˜30° C. for a polymerization reaction for 60 minutes, the reaction was not suspended until the conversion rate reached 60% to form a semi-emulsion A;
performing a second-stage polymerization reaction: the emulsion B was added dropwise at a rate of 8 mL/min to the semi-emulsion A while the semi-emulsion A was stirred at a rotation speed of 300 rpm, addition of the emulsion B was suspended when an amount of 50% of the emulsion B was added, 2 g of azodiisobutylamine hydrochloride with a mass concentration of 5% was added to a system under the protection of nitrogen gas, and the polymerization reaction was performed at 30° C. for another 60 minutes; and
performing a third-stage polymerization reaction: still under the protection of nitrogen gas, a remaining 50% of the emulsion B was added dropwise at a rate of 2 mL/min while the polymerization reaction continued, after the whole emulsion B was added, the reaction was carried out at 70° C. for 4 hours until the reaction was completed, so as to obtain the invert emulsion having double particle size distribution.

An invert emulsion having particle size distribution between 20 nm and 70 nm and between 100 nm and 500 nm can be obtained by the above-mentioned preparation method. The invert emulsion is used as a water treatment flocculant, a sludge dewatering agent and a papermaking auxiliary agent, and in particular, the sludge dewatering agent fabricated from the invert emulsion in this example is used for dewatering sludge. Only the invert emulsion provided in this example is used, and other inorganic conditioners or various organic conditioners are not needed to achieve a filter cake water content of below 50% after sludge dewatering.

### Control Example 1

This control example is compared with example 1. On the basis of experimental data of Example 1, a conventional invert emulsion polymerization method is directly adopted instead of distributed emulsification and multi-stage polymerization. Detailed steps are as follows:
first of all, 531 g of methacryloyloxyethyl trimethylammonium chloride, 141 g of dimethyldiallyl ammonium chloride, 38 g of deionized water and 0.15 g of polyethylene glycol diacrylate were added to a beaker, after all of those components were mixed well and dissolved completely to form a resulting solution, the pH of the solution was adjusted to 3.5 to obtain an aqueous monomer solution;
then 37 g of S-80, i.e. sorbitol monooleate, 33 g of T-81, i.e. polyoxyethylene sorbitol monooleate, and 220 g of industrial white oil 5 # were added to a reactor and mixed well, then an oil phase was formed, the aqueous monomer solution was added while agitated at a rotation speed of 800 rpm, followed by shear and dispersion on a homogeneous emulsifying machine for 10 minutes, and nitrogen was introduced into the solution and oxygen was removal from the solution for 60 minutes, a solution of 0.2 g of ammonium persulfate solution with a mass concentration of 10% was added, and it was mixed for 10 minutes, then a solution of sodium metabibisulfite with a mass concentration of 0.3% was slowly added dropwise at 10° C. for a polymerization reaction for 5 hours, finally, an invert emulsion sample was obtained.

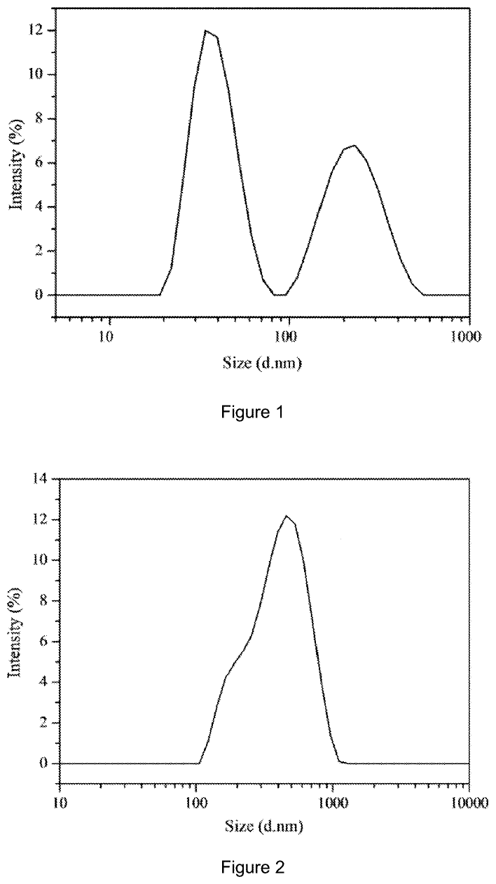

The particle size and distribution of the invert emulsion samples prepared in Control Example 1 and Example 1 were analyzed and compared with each other. DLS diagrams were plotted, as shown in FIGS. 1 and 2: wherein the ordinate is the light intensity, and the abscissa is the particle size; FIG. 1 is a DLS diagram of an invert emulsion sample prepared in Example 1; and FIG. 2 is a DLS diagram of an invert emulsion sample prepared by the conventional invert emulsion polymerization method in Control Example 1.

Plotting of the DLS diagram: appropriate amounts of the invert emulsion samples prepared in Example 1 and Control Example 1 were measured and diluted with white oil 20 times, the particle size of the emulsion was tested on 5022f dynamic/static laser light scattering instrument (DLS), and its results were shown in FIGS. 1 and 2; it can be seen from FIG. 1 that the particle size of the invert emulsion prepared in one step by means of the distributed emulsification and the multi-stage polymerization technique provided in Example 1 has an obvious bimodal distribution, which is between 20 nm and 70 nm and between 100 nm and 500 nm, respectively; it can be seen from FIG. 2 that the invert emulsion sample prepared by the conventional invert emulsion polymerization method in Control Example 1 has only one particle size distribution peak which is between 100 nm and 1000 nm, and the particle size distribution is relatively wide.

### Control Example 2

This control example is compared with Control Example 1. In this control example, an invert emulsion having two different particle sizes are prepared by the conventional invert emulsion polymerization method provided in Control Example 1 instead of the preparation method for the invert emulsion provided in Example 1, and the prepared invert emulsion is physically mixed to obtain a compound emulsion.

The particle size and distribution of the invert emulsion samples prepared in Control Example 1, Control Example 2 and Example 1 were analyzed and compared with each other, and TEM images were drawn;

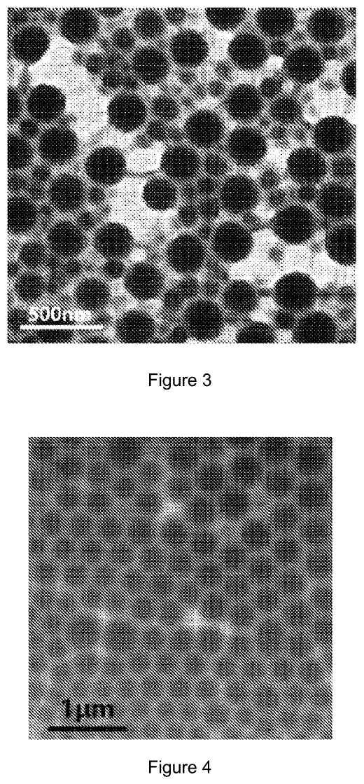

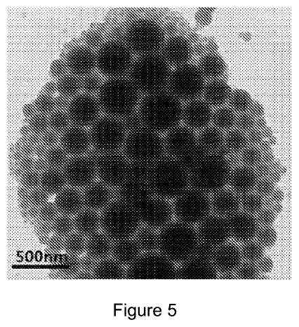

TEM image: appropriate amounts of the invert emulsion samples of Example 1 and Control Example 1 and Control Example 2 were measured and diluted with petroleum ether, the diluted emulsion samples were dropped on a copper mesh to make a sample, and morphology and size of the emulsion particles were observed under a Tecnail2 Transmission Electron Microscope (TEM), results are shown in FIGS. 3, 4 and 5. FIG. 3 is a TEM image of an invert emulsion sample prepared by a preparation method in Example 1; FIG. 4 is a TEM image of an invert emulsion sample prepared by a conventional invert emulsion preparation method in Control Example 1; and FIG. 5 is a TEM image of a compound emulsion sample obtained from physical mixing of emulsions having different particle sizes in Control Example 2. It can be seen from the TEM images that samples prepared by the distributed emulsification and the multi-stage polymerization technique provided in Example 1, that is, the invert emulsion sample of Example 1 as shown in FIG. 3, the emulsion particle thereof are regular spherical, and it is obvious that there are two particle sizes which are basically distributed between 20 nm and 70 nm and between 100 nm and 500 nm. Such results are substantially the same as those shown in the DLS diagram of FIG. 1. The emulsion particles having these two sizes are interspersed with each other, particles having large particle size are uniformly distributed among particles having small particle size, and the particles having small particle size are uniformly distributed among the particles having large particle size. The invert emulsion sample prepared by the conventional invert emulsion technique in Control Example 1, as shown in FIG. 4, is also basically regular spherical, but the particle size of the emulsion particles is similar without an enormous difference; in addition, as shown in FIG. 5, Control Example 2 is a compound emulsion sample obtained by preparing two emulsions by using the conventional invert emulsion method and physically mixing the emulsion. It can be seen from the TEM image that samples obtained by the physical mixing also have different particle sizes, wherein particles having large particle size are basically concentrated together, and particles having small particle size are basically concentrated together. So it is clear that there is no particle size distribution pattern of the invert emulsion prepared in one step by the method in the present invention.

The dewatering performance of the invert emulsion samples prepared in Control Example 1, Control Example 2 and Example 1 was evaluated and tested. The invert emulsion prepared in Example 1 was sample 1, the invert emulsion sample prepared in Control Example 1 was sample 2, and the compound emulsion sample prepared in Control Example 2 was sample 3. The laboratory simulated the method of using sludge dewatering agent on site. Specifically, three groups of samples were dissolved at a certain concentration of 0.4% in this experiment; three equal parts of sludge were obtained; and a source of the sludge was from a water treatment plant in Zhangjiagang City, Jiangsu Province. A certain amount of the dissolved sample was added to the sludge, the sludge was stirred for some time to flocculate the sludge, then the flocculated sludge was filtered, the free water was filtered out; the filter cake on a filter paper was pressed with a simulated plate frame filter unit for a pressing test. The pressed piece was the filter cake, and the water content of the filter cake was detected; experimental results are shown in Table 1:

TABLE 1

| | | | Solid | Water |
|---|---|---|---|---|
| | | | Content of | Content of |
| Sample | | | Filter | Filter |
| Name | Example | Preparation Method | Cake/% | Cake/% |
| Sample 1 | Example1 | preparation method | 50.9 | 49.1 |
| | | provided in Example 1 | | |
| Sample 2 | Control | conventional invert | 34.5 | 65.5 |
| | Example1 | emulsion polymerization | | |
| | | method | | |
| Sample 3 | Control | obtained from physical | 41.8 | 58.2 |
| | Example2 | mixing of two | | |
| | | conventional invert | | |
| | | emulsion samples | | |

As can be seen from Table 1, when the sludge dewatering experiment is carried out by using the invert emulsion sample 1 having double particle size distribution synthesized by the preparation method proposed in Example 1, the water content of the filter cake could be reduced to below 50% after pressing; while the sludge dewatering experiment is carried out by using the sample 2 prepared by the conventional invert emulsion technique, the water content of the filter cake is greater than 60%. Therefore, it is clear that and the dewatering effect is obviously worse than that of the sample provided by the present invention. In addition, the dewatering effect of the compound emulsion sample 3 obtained from physical mixing is better than that of the sample 2 but worse than that of the sample 1. It thus appears that the invert emulsion having double particle size distribution prepared by the preparation method proposed in Example 1 has certain advantages in sludge dewatering.

Through comparison and analysis of the experiments between Example 1, and Control Example 1, and between Example 1 and Control Example 2, respectively, an invert emulsion having different particle sizes in one step are prepared by means of a multi-stage polymerization reaction, by controlling an emulsifier system and an emulsification means in Example 1, wherein the particle size of the emulsion has bimodal distribution, and the particle size of particles in the invert emulsion is between 20 nm and 70 nm and between 100 nm and 500 nm. This two groups of particles having different particle sizes can be interspersed with each other. Particles having large particle size are uniformly distributed among particles having small particle size, and the particles having small particle size are uniformly distributed among the particles having large particle size. A macromolecule of the large particle size part has high cationic charge density and low molecular weight, and a macromolecule of the small particle size part has low cationic charge density and high molecular weight. The high cationic charge density of the former has a destructive effect on the cell wall, and the high molecular weight of the latter has a strong flocculating effect. Both are uniformly distributed when in use, so that they can cooperate with each other to achieve better effects. The invert emulsion can be independently used as a sludge dewatering agent and it can achieve an excellent effect. Specifically, water content of a filter cake is below 50% after sludge dewatering, and the present invention has advantages of having high solid content which is above 50%, low consumption, low costs, fast dissolution, being convenient to use. It can dissolve completely within 3 minutes, so that it can meet the requirements of instant dissolution.

From the experimental results in Table 1, it can be concluded that the sludge dewatering performance of emulsion products having different particle size distribution is different, and the structure determines the performance; it can be seen from FIGS. 1 and 2, the invert emulsion sample in Example 1 has double particle distribution, a macromolecule of the large particle size part has high cationic charge density and low molecular weight, and a macromolecule of the small particle size part has low cationic charge density and high molecular weight. The high cationic charge density of the former has a destructive effect on the cell wall, and the high molecular weight of the latter has a strong flocculating effect. Both are uniformly distributed when in use, so that they can cooperate with each other to achieve better effects. While the sample in Control Example 1 has only one particle size distribution, and the flocculation and dewatering effects are not as good as those in Example 1.

As can be seen from FIG. 3, for the invert emulsion having double particle size distribution of Example 1, latex particles having two particle sizes can be interspersed with each other. Particles having large particle size are uniformly distributed among particles having small particle size, and the particles having small particle size are uniformly distributed among the particles having large particle size. On one hand, an interaction force exists between the large particles and the small particles, making the emulsion particles more stable; on the other hand, when in use, the particles, large and small, release active substances (macromolecules) tangled together after resolved in solution, wall-breaking performance of the large particles, and the flocculation performance of the small particles work together, which improves the dewatering efficiency.

It can be seen from FIGS. 4 and 5 that the particle size in Control Example 1 is single-distributed and does not have the synergistic effect of the large and small particles mentioned in Example 1, so the sludge dewatering performance is poor; in Control Example 2, although the emulsion having the two particle sizes is stirred evenly, it can be seen from the TEM image that the large particles and the small particles are still concentrated respectively, and there is no uniform distribution of the large and small particles in Example 1; on the one hand, the distribution in Control Example 2 is not conducive to the stability of the emulsion, since the large particles will settle faster after agglomeration, and then the small particles will agglomerate and settle; on the other hand, when used as a flocculation and dewatering agent for dissolving, dissolving rates of the large and small particles are quite different, and the effective substances (macromolecules) produced after dissolving are entangled with each other, and synergy does not work well, so the sludge dewatering performance is slightly worse than that of the invert emulsion sample prepared in Example 1, which is verified by the experimental results in Table 1.

The above descriptions are only the preferred embodiments of the invention, not thus limiting the embodiments and scope of the invention. Those skilled in the art should be able to realize that the schemes obtained from the content of specification and drawings of the invention are within the scope of the invention.

1. An invert emulsion having double particle size distribution, the invert emulsion having a particle size distribution of latex particles between 20 nm and 70 nm and between 100 nm and 500 nm in the same invert emulsion system.

2. A preparation method for the invert emulsion of claim 1 comprises: forming an emulsion A and an emulsion B having different particle sizes by controlling an emulsifier system and an emulsification means, and preparing in one step an invert emulsion the particle size of which has bimodal distribution by means of a three-stage polymerization reaction between the emulsion A and the emulsion B in the same system.

3. The preparation method for the invert emulsion of claim 2, wherein a preparation method for the emulsion A and the emulsion B comprises:
preparing the emulsion A: adding a compound emulsifier A and oil to a reactor A, and stirring the compound emulsifier A and the oil well to form an oil phase A; adding a functional monomer A aqueous solution while stirring the mixture at a rotation speed of 600-1000 rpm, then performing shearing and dispersion on a homogeneous emulsifying machine for a period of 5 to 20 minutes to obtain the emulsion A;
preparing the emulsion B: adding a compound emulsifier B and oil to a batching kettle B, and stirring the compound emulsifier B and the oil well to form an oil phase B; adding a functional monomer B aqueous solution while stirring the mixture at a rotation speed of 100-300 rpm, then keeping stirring for a period of 10 to 30 minutes at the same rotation speed of 100-300 rpm to obtain the emulsion B.

4. The preparation method for the invert emulsion of claim 2, wherein the method for preparing in one step an invert emulsion the particle size of which has bimodal distribution by means of a three-stage polymerization reaction between the emulsion A and the emulsion B in the same system comprises:
performing a first-stage polymerization reaction: an initiator A is added to the emulsion A under the protection of nitrogen gas, and the polymerization reaction is performed at 10-30° C. for a period of 30-90 minutes, the reaction is not suspended until the conversion rate reaches 40-60% to form a semi-emulsion A;
performing a second-stage polymerization reaction: the emulsion B is added dropwise to the semi-emulsion A while the semi-emulsion A is stirred at a rotation speed of 300-600 rpm, addition of the emulsion B is suspended when an amount of 40-80% of the emulsion B is added, an initiator B is added to a system under the protection of nitrogen gas, and the polymerization reaction is performed at 30-60° C. for another period of 30-90 minutes; and
performing a third-stage polymerization reaction: still under the protection of nitrogen gas, a remaining 20-60% of the emulsion B is added dropwise while the polymerization reaction continues, after the whole emulsion B is added the reaction is carried out at 50-90° C. for a period of 2-5 hours until the reaction is completed, so as to obtain the invert emulsion having double particle size distribution.

5. The preparation method for the invert emulsion of claim 2, wherein a ratio of the emulsion A to the emulsion B is in a range of 1/1 to 4/1.

6. The preparation method for the invert emulsion of claim 3, wherein the compound emulsifier A has a HLB of 5-9, an amount of the compound emulsifier A accounts for 2 to 4% by mass of the total amount of the system; the compound emulsifier B has a HLB of 2-5, an amount of the compound emulsifier B accounts for 1 to 3% by mass of the total amount of the system.

7. The preparation method for the invert emulsion of claim 3, wherein the functional monomer A aqueous solution is a mixture formed from a complete dissolution of a functional monomer A, water and an auxiliary agent; the functional monomer A is one or two or more selected from the group consisting of acrylamide, methacrylamide, methacryloyloxyethyltrimethylammonium chloride, acryloyloxyethyltrimethylammonium chloride, dimethyldiallylammonium chloride, methylacryloyloxyethyldimethylbenzylammonium chloride and methacryloylpropyltrimethylammonium chloride.

8. The preparation method for the invert emulsion of claim 3, wherein the functional monomer B aqueous solution is a mixture formed from a complete dissolution of a functional monomer B, water and an auxiliary agent; the functional monomer B is an unsaturated quaternary ammonium salt; a ratio of the functional monomer A to the functional monomer B is in a range of 1/2 to 4/1.

9. The preparation method for the invert emulsion of claim 4, wherein the initiator A is a redox initiator, an amount of the initiator A accounts for 0.0005 to 0.01% by mass of the total amount of the system; the initiator B is an azo initiator, an amount of the initiator B accounts for 0.005 to 0.02% by mass of the total amount of the system; a rate of adding the emulsion B dropwise in the second-stage polymerization reaction is in a range of 5-10 mL/min, and a rate of adding the emulsion B dropwise in the third-stage polymerization reaction is in a range of 0.5-5 mL/min.

10. A use of the invert emulsion of claim 1, wherein the invert emulsion is used as a water treatment flocculant, a sludge dewatering agent and a papermaking auxiliary agent.

11. The preparation method for the invert emulsion of claim 3, wherein the method for preparing in one step an invert emulsion the particle size of which has bimodal distribution by means of a three-stage polymerization reaction between the emulsion A and the emulsion B in the same system comprises:
performing a first-stage polymerization reaction: an initiator A is added to the emulsion A under the protection of nitrogen gas, and the polymerization reaction is performed at 10-30° C. for a period of 30-90 minutes, the reaction is not suspended until the conversion rate reaches 40-60% to form a semi-emulsion A;
performing a second-stage polymerization reaction: the emulsion B is added dropwise to the semi-emulsion A while the semi-emulsion A is stirred at a rotation speed of 300-600 rpm, addition of the emulsion B is suspended when an amount of 40-80% of the emulsion B is added, an initiator B is added to a system under the protection of nitrogen gas, and the polymerization reaction is performed at 30-60° C. for another period of 30-90 minutes; and
performing a third-stage polymerization reaction: still under the protection of nitrogen gas, a remaining 20-60% of the emulsion B is added dropwise while the polymerization reaction continues, after the whole emulsion B is added the reaction is carried out at 50-90° C. for a period of 2-5 hours until the reaction is completed, so as to obtain the invert emulsion having double particle size distribution.

12. The preparation method for the invert emulsion of claim 3, wherein a ratio of the emulsion A to the emulsion B is in a range of 1/1 to 4/1.

13. The preparation method for the invert emulsion of claim 7, wherein the functional monomer B aqueous solution is a mixture formed from a complete dissolution of a functional monomer B, water and an auxiliary agent; the functional monomer B is an unsaturated quaternary ammonium salt; a ratio of the functional monomer A to the functional monomer B is in a range of 1/2 to 4/1.

14. A use of the invert emulsion of claim 2, wherein the invert emulsion is used as a water treatment flocculant, a sludge dewatering agent and a papermaking auxiliary agent.

15. A use of the invert emulsion of claim 3, wherein the invert emulsion is used as a water treatment flocculant, a sludge dewatering agent and a papermaking auxiliary agent.
